(19) United States
(12) Patent Application Publication
(10) Pub. No.: US 2005/0165679 A1
(43) Pub. Date: Jul. 28, 2005

(54) SYSTEM AND METHOD FOR FUND RAISING

(75) Inventors: Terry L. Henlley, Troy, OH (US); Don E. Campbell, Dayton, OH (US)

Correspondence Address: A PATENT LAWYER CORP, PC;R WILLIAM GRAHAM, 22 S ST CLAIR ST, DAYTON, OH, 45402, US

(73) Assignees: Mr.Terry L. Henley, Troy, OH (US); Mr. Don E. Campbell, Dayton, OH (US)

(21) Appl. No.: 10/907,623

(22) Filed: Apr. 8, 2005

Related U.S. Application Data
(63) Continuation-in-part of application No. 10/414,728, filed on Apr. 16, 2003.

(51) Int. Cl. G06F 17/60

(52) U.S. Cl. 705/40; 705/34

(57) ABSTRACT

A system and method for fund raising includes the steps of employing an interactive device, which can be a telephone or television, for example, operably associated with means for automatically billing an authorized donation charge onto a predetermined phone bill, prompting a party through the interactive device to authorize a donation charge to the predetermined phone bill, and interacting with the interactive device by the party to cause at least one of the authorization of the donation charge or denial of the donation charge. A system to perform these steps is also provided. The interactive device can also provide for selecting a desired amount of donation charge. There is also preferably automatically provided through the interactive device a donation receipt to the party upon authorizing the donation charge. The interactive device can also include means for automatically generating a solicitation letter to the party.

This is a continuation-in-part of co-pending application Ser. No. 10/414,728 filed Apr. 16, 2003.

### BACKGROUND OF THE INVENTION

1. Field of the Invention

The present invention relates to a system and method for fund raising. More particularly, the present invention relates to a billing system and method for fund raising for hospital foundation for purposes via engaging a patient as a client and assuring that charges are properly authorized by such patient.

2. Background of the Invention

A number of ways currently exist for raising funds by charitable and other non-profit organizations. A traditional approach is through direct mail and telemarketing wherein there is solicitation of monetary donations by members of the organization and by non-members who support the goals and programs of such organizations.

Raffles or giveaways are another approach wherein goods and/or services are requested from retailers and vendors for prizes at social events and functions of the organizations. The events typically charge a fee to participate. The donor is typically philanthropically motivated or desiring to promote good will for business.

While these approaches have met with success in the past, they are not target always very effective in being target oriented. Unless, the recipient is in a particularly giving mind set, the solicitation effort will not produce any revenue.

Further, historically, there are a given number of major donors, such as large corporations, in a community which are easily identified targets and receive hundreds of solicitations and thus becoming one of the few recipients is a challenge. Other people who would otherwise be willing to make direct donations to the organization are sometimes unable to do so or are limited in the amount they can donate because of limitations in their finances or more pressing financial obligations.

Further, obtaining information relating to a particular donor party is sometimes difficult and inaccurate. Thus, there remains a need to improve the method and system for fund raising. The present invention solves the need in a particular environment as described herein.

### SUMMARY OF THE INVENTION

An object of the present invention is to provide an improved method for fund raising by non-profit organizations.

Another object is to provide an improved system for fund raising by non-profit organizations.

Still another object of the present invention is to provide an improved system and method for fund raising by hospital foundations.

A further object is to provide a billing system for donations provided wherein the donor receives a charitable donation receipt.

Another object of the present invention is to provide for a billing system in a hospital for donations provided wherein the donor receives a charitable donation receipt.

Still another object of the present invention is to ensure proper authorization of the donation is made by the donor.

Another object is to provide automated billing of donation charges.

An additional object of the present invention is to provide a method and system which will reduce the amount of administrative and cost in fund raising.

Accordingly, one embodiment of the present invention is directed to a method for fund raising for a foundation. The method includes the steps of employing an interactive device, which can be a telephone or television, for example, operably associated with means for automatically billing an authorized donation charge onto a predetermined phone bill, prompting a party through the interactive device to authorize a donation charge to the predetermined phone bill, and interacting with the interactive device by the party to cause at least one of the authorization of the donation charge or denial of the donation charge. A system to perform these steps is also provided. The system can also provide for selecting a desired amount of donation charge. There is also preferably automatically provided through the interactive device a donation receipt to the party upon authorizing the donation charge. The system can also include means for automatically generating a solicitation letter to the party.

The method and system can be employed in a hospital wherein the party can be an admitted patient. The means for automatically billing can include billing and verification software for accurately verifying billing information provided by the party for purposes of engaging the party as a donor and assuring that predetermined charges are properly authorized by the donor. The billing system includes a computer based device which has operating software, billing and verification software operably associated therewith. The billing and verification software is operably associated with a telephone service provider database, wherein the telephone service provider database preferably can include a data listing of telephone numbers having associated street addresses and associated names. The billing and verification software is capable of receiving provided billing information data and comparing the provided billing information data with the data listing of telephone numbers, addresses and names and generating a signal indicative of one of confirming or not confirming provided billing information data.

Further, upon confirming the provided billing information data, the billing and verification software authorizes a predetermined type of charge to be made by the party using the provided billing information data. In one embodiment, the data listing of telephone numbers is characterized as a listing of parties' telephone numbers, names, and addresses having an established account with a telephone service provider. The billing and verification software is equipped to bill the charges of the predetermined type through the established account for such party.

These and various other advantages and features of novelty which characterize the invention are pointed out with particularity in the claims annexed hereto and forming a part hereof. However, for a better understanding of the invention, its advantages and objects attained by its use, reference should be had to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram of an embodiment of the present invention.

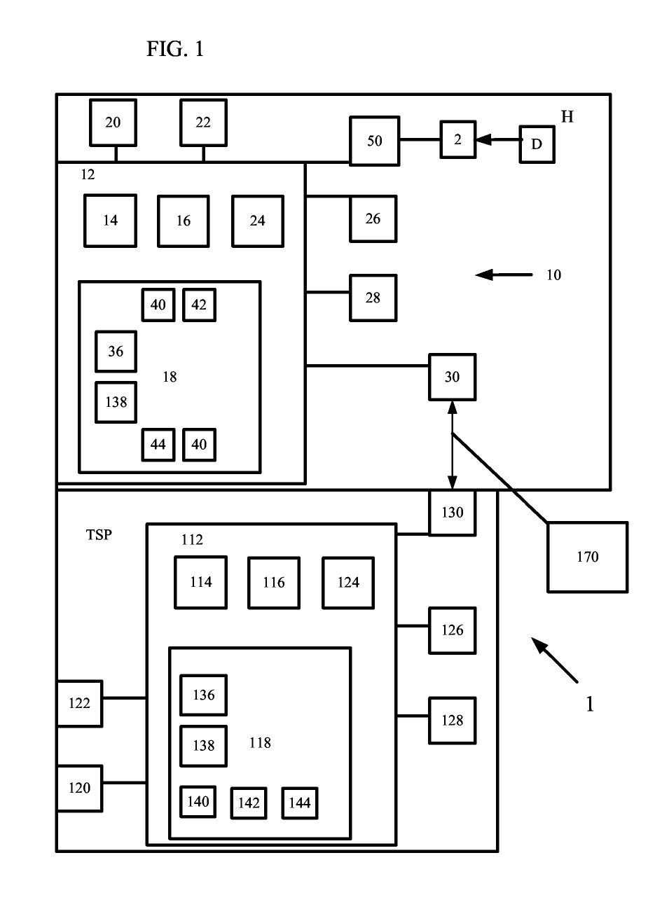

### DETAILED DESCRIPTION

While the present invention contemplates the use of the method and system in various settings, the present invention provides the exemplary embodiment for use with soliciting a donor D in a hospital H. It is appropriate to briefly describe the typical admittance procedure within a hospital.

A patient enters the admittance area, wherein pertinent patient history information as well as billing information is acquired. Part of this information includes a personal phone number.

After admittance, a patient is typically placed in a room within the hospital. The room is equipped with services such as local and long distance telephone service and television service. As noted in commonly owned co-pending application Ser. No. 10/414,728, these non-medical costs are typically billed to the patient using the provided patient billing information, as opposed to reimbursement via medical insurance. Accordingly, if false or incorrect patient billing information is provided, these costs are generally not recovered. In cases where false or incorrect information is provided by the patient, costs associated with the patient's care and stay in the hospital are not paid which contributes to increasing cost of medical care. Like all businesses, hospitals are in a competitive environment in which they pay closer attention to profitability. As an extension of the billing system heretofore, the present invention offers a system and method which solves a need to improve and maximize for fund raising techniques by in part employing the billing system. In addition, there is presented a novel fund raising system and method.

Referring now to the drawing, the system for fund raising for a foundation is generally designated by the numeral 1. The system 1 includes an interactive device 2, which can be a telephone or television, for example, operably associated with billing system 10 for automatically billing an authorized donation charge onto a predetermined phone bill.

The billing system 10 includes billing and verification software 138 as described herein which includes capability of prompting a party, such patient donor D, through the interactive device 2 to authorize a donation charge to the donor's phone bill. The billing and verification software 138 permits the donor D to interact with the interactive device 2 to cause either the authorization or denial of the donation charge to be made to the donor's phone bill. The billing and verification software 138 can also provide for selecting a desired amount of donation charge through the interactive device 2. For example, in the case of the interactive device 2 being a phone, the party can select numbers on the phone as to the amount, likewise, in the case of the interactive device being a television, the user can select keys on a remote control for the television.

The billing and verification software 138 also can preferably automatically generate a donation receipt to the donor upon receiving a signal authorizing the donation charge. Further, the billing and verification software 138 can also automatically generate a solicitation letter to the party.

The system 1 can be employed whenever the interactive device 2 is turned on or active. In such case, the party/donor would either via audio and or visual receive a prompt for a donation to a predetermined foundation. At this point, the party/donor is required by the billing and verification software 138 to select to donate or not as described.

The billing system 10 provides for accurately verifying billing information provided by a party for purposes of engaging the party as a client/donor and assuring that charges of a predetermined type are properly authorized by the client/donor. The billing system 10 can include a conventional computer 12 having a central processor (CPU) 14, random memory 16, permanent memory 18 (e.g., hard or fixed disk, optical disk, magneto-optical disk, or flash memory), and can include a keyboard 20, a mouse 22 (or like pointing device), a clock 24 and a display or screen device 26, otherwise known in the art to lend functionality to the computer 12 capable of running standard operating system software such as Windows, Linux, or Unix. Processor 14 is operably associated with memory 16 for storing frequently accessed information. One or more input/output device(s) 28, such as a printer can be included. The computer 12 can preferably include a communication link 30 which can be a LAN, WAN, modem connection or other communication line, for example. Operably residing on the computer 12 is operating system software 36 and can be, for example, of a type described above or is known in the art. The operating software 36 is preferably stored in memory 18, and can include a one or more application programs as is known in the art.

Another computer 112 can be provided which has a central processor (CPU) 114, random memory 116, permanent memory 118, and can include a keyboard 120, a mouse 122, a clock 124 and a display or screen device 126, input/output device(s) 128, and a communication link 130, for example. Similarly, residing on the computer 112 is operating software 136 and includes a one or more applications as above. It should be noted that the invention can be modified, e.g., to add or delete devices, such as device 128, so long as the ability to perform the intended objectives of the invention can be carried out.

In this example, the computer 12 can be located at hospital H, and the computer 112 can be remotely located site, e.g., at a telephone service provider site TSP. Billing and verification software 138 is operably associated with a telephone service provider database 140 which is shown here on a memory 118, but could be remotely located on another computer or additionally on computer 12 and work in cooperation with such software 138. The telephone service provider database 140 includes a data listing 142 of telephone numbers each having associated street addresses and associated names.

The billing and verification software 138 is capable of receiving billing information data 40 which is shown here, by way of example, on computer 12 and comparing the provided billing information data 40 with the data listing 142 of telephone numbers, addresses and names in the telephone service provider database 140. In this example, the billing and verification software 138 can generate and communicate a signal to the computer 12 indicative of one of confirming or not confirming provided billing information data 40.

Upon confirming the provided billing information 40, the billing and verification software 138 authorizes predetermined charges to be made by the party using the provided billing information 40. In a preferred embodiment, each listed telephone number in the data listing 142 is on an established account with a telephone service provider TSP, the billing software 138 is equipped to bill the predetermined charges through the established account.

It is noted that the billing and verification software 138 can be operatively residing on either or both of the computers 12 and 112. It is further contemplated that the billing and verification software 138 could be web-based and that browser technology can be employed to employ the use of the software 138. Thus, the location of the billing software 138 can be so situated to carry out the invention.

The billing and verification software 138 is capable of associating, logging and storing of billing information data 40 into a client data file 42 via a client screen which displays client name field, contact name field, street address field, city address field, state zip code field, country field, work, fax and home telephone fields and creates a unique identification for each client. Likewise, the billing and verification software 138 provides entry of service provider data 44 into a service provider data file 46 via a service provider screen having company name field, service provider name field, street address field, city address field, state zip code field, country field, work, fax and home telephone fields, predetermined types of charge fields and unique identification for the service provider is permitted and stored in the service provider data file 46. Further, the billing and verification software 138 provides for associating and accruing charges of predetermined types of services/goods obtained or used by a particular client to be billed and writing and storing such all accrued charges into a billing data file 144.

Upon initiation, the billing and verification software 138 provides displays a screen (e.g., a windows-based screen) on the monitor 26 prompting the service provider to enter the billing information data 40. If the service provider cancels the operation, billing software 138 provides for the screen to minimize, and also optionally provides for exiting of the billing software 138. Upon logging the billing information data 40, billing and verification software 138 can preferably perform a verification of the billing information data 40 by comparing against the data listing 142 in the database 140 and displays a screen confirming or not confirming the billing information data 40. If confirming, the billing and verification software 138 enables predetermined types of services/goods to be accrued through to the billing data file 144 as set forth above.

In the case of telephone charges being a type of predetermined chargeable item, a telephone system 50, having a plurality of phones, which can include interactive device 2, a phone in the room, operably connected thereto, is operably connected to the computer 12 such that the billing and verification software 138 can automatically accrue charges associated with a particular phone in the phone system 50 and associate the charges, with corresponding client data and service provider data into the billing data file 144. If not confirmed, billing and verification software 138 generates a call signal to an alternative billing mechanism 170 (such as a billing call center), wherein the alternative billing center 170 is equipped to handle credit card billing or other suitable billing arrangement between the client and the service provider.

The billing and verification software 138 is preferably continuously running to receive charges to the billing data file 144 and in turn, the billing and verification software 138 generates an invoice (by way of any suitable printing means) to the client on behalf of the service provider. Herein, the invoice generated would include listing the client data and service provider data with itemized call time data (i.e., services/goods provided).

The above described embodiment is set forth by way of example and is not for the purpose of limiting the present invention. It will be readily apparent to those skilled in the art that obvious modifications, derivations and variations can be made to the embodiment without departing from the scope of the invention. Accordingly, the claims appended hereto should be read in their full scope including any such modifications, derivations and variations.

1. A method for fund raising, which includes the steps of:
employing an interactive device which is operably associated with means for automatically billing an authorized donation charge onto a predetermined phone bill of a donor party;
prompting the donor party through said interactive device to authorize a donation charge to the predetermined phone bill; and
interacting with said interactive device by said donor party to cause at least one of authorization and denial of said donation charge.

2. The method of claim 1, wherein said means for automatically billing provides for selecting a desired amount of donation charge.

3. The method of claim 1, which includes the step of automatically providing a donation receipt to said donor party upon authorization of said donation charge.

4. The method of claim 1, which includes automatically generating a solicitation letter to the donor party.

5. A system for fund raising, which includes:
an interactive device;
means operably associated with said interactive device for automatically billing an authorized donation charge onto a predetermined phone bill of a donor party, wherein said billing means prompts said donor party through said interactive device to authorize a donation charge to the predetermined phone bill interactive device and enables said donor party to interact with said interactive device to cause at least one of authorization and denial of said donation charge.

6. The system of claim 5, wherein said means for automatically billing provides for selecting a desired amount of donation charge.

7. The system of claim 5, wherein said billing means automatically providing a donation receipt to said donor party upon authorization of said donation charge.

8. The system of claim 5, which includes means for automatically generating a solicitation letter to said donor party.

9. The system of claim 5, wherein said billing means includes a computer based device which includes operating software, billing and verification software operably associated therewith, wherein said billing and verification software is operably associated with a telephone service provider database, wherein said telephone service provider database includes a data listing of telephone numbers each having an associated street address and party name, and said billing and verification software is capable of receiving billing information data which is provided by the party and comparing said provided billing information data with said data listing of telephone numbers, addresses and names and generating a signal indicative of one of confirming and not confirming provided billing information data.

10. The system of claim 9, wherein said billing and verification software authorizes a predetermined type of charge to be made by the party using the provided billing information data upon confirming said billing information data.

11. The system of claim 10, wherein said data listing of telephone numbers is characterized as a data listing of telephone numbers, names, and addresses having an established account with a predetermined telephone service provider.

12. The system of claim 11, wherein said billing and verification software is equipped to bill said charge of said predetermined type through said established account for such party.

13. The system of claim 12, wherein said computer based device is employed at a hospital and operably connected to a telephone system at said hospital in a manner to permit said billing and verification software to accrue said charge.

14. The system of claim 10, wherein said computer based device is employed at a hospital and operably connected to a telephone system at said hospital in a manner to permit said billing and verification software to accrue said charge.

15. The system of claim 10, wherein said computer based device is employed at a hospital and operably connected to a television system at said hospital in a manner to permit said billing and verification software to accrue said charge.

16. The system of claim 12, wherein said computer based device is employed at a hospital and operably connected to a television system at said hospital in a manner to permit said billing and verification software to accrue said charge.

17. The billing system of claim 9, wherein said billing and verification software sends a signal to employ an alternative billing mechanism upon not confirming said billing information data.
